(19) United States
(12) Patent Application Publication
(10) Pub. No.: US 2012/0126132 A1
(43) Pub. Date: May 24, 2012

(54) X-Ray Detector and Method of Driving the Same

(75) Inventor: Hisashi Kimura, Yongin-City (KR)

(73) Assignee: SAMSUNG MOBILE DISPLAY CO., LTD., Yongin-City (KR)

(21) Appl. No.: 13/237,454

(22) Filed: Sep. 20, 2011

(30) Foreign Application Priority Data
Nov. 23, 2010 (KR) 10-2010-0117097

(51) Int. Cl. G01T 1/24

(52) U.S. Cl. 250/370.09; 250/371

(57) ABSTRACT

An X-ray detector comprises: a plurality of light sensing pixels including a photodiode generating an electrical detection signal corresponding to incident light and a switching device transmitting the detection signal; a gate driver supplying to the switching device, via a plurality of gate lines, a gate pulse for turning on the switching device; and a read out integrated circuit for reading out the detection signal from the plurality of light sensing pixels. Gate pulses supplied to at least two gate lines partially overlap one another during a scrubbing period in which gate scanning is performed at least one time in order to initialize the photodiode of the plurality of light sensing pixels. Accordingly, the X-ray detector maintains image lag removing efficiency and initialization time of the X-ray detectors is reduced.

### CLAIM OF PRIORITY

This application makes reference to, incorporates the same herein, and claims all benefits accruing under 35 U.S.C. §119 from an application earlier filed in the Korean Intellectual Property Office on Nov. 23, 2010 and there duly assigned Serial No. 10-2010-0117097.

### BACKGROUND OF THE INVENTION

1. Field of the Invention

The present invention relates to X-ray detectors and methods of driving the X-ray detectors.

2. Description of the Related Art

X-rays having a short wavelength may easily pass through a subject. The amount of X-rays which penetrate through the subject is affected by the density of a part of the subject. That is, the state of an inner part of the subject may be indirectly observed through the amount of X-rays which penetrate through the subject.

X-ray detectors detect the amount of X-rays penetrating the subject. The X-ray detectors detect the amount of X-rays which penetrate, and may display a state of an inner part of the subject on a display device. X-ray detectors may generally be used in examination apparatuses such as a medical examination apparatus, a nondestructive inspection apparatus, etc.

At present, a flat panel digital radiography (DR) method, which uses DR and does not use a film, is widely used as an X-ray detector.

An X-ray detector is initialized by using scrubbing, which refers to repeated gate-scanning of the X-ray detector. The X-ray detector may remove image lags of previously captured images by performing the scrubbing.

### SUMMARY OF THE INVENTION

The present invention provides X-ray detectors and methods of driving the X-ray detectors for which an initialization time of the X-ray detectors is reduced while image lag removing efficiency is maintained.

According to an aspect of the present invention, an X-ray detector comprises: a plurality of light sensing pixels including a photodiode for generating an electrical detection signal corresponding to incident light and a switching device for transmitting the detection signal; a gate driver for supplying a gate pulse to the switching device via a plurality of gate lines for turning on the switching device; and a read out integrated circuit for reading out the detection signal from the plurality of light sensing pixels; wherein gate pulses supplied to at least two gate lines partially overlap one another during a scrubbing period in which gate scanning is performed at least one time in order to initialize the photodiode of the plurality of light sensing pixels.

The gate pulse supplied to each of the gate lines may have a pulse width corresponding to n clock cycles (where n is a natural number smaller than or equal to the number of rows of the plurality of light sensing pixels), and may be overlapped with the gate pulse supplied to an adjacent gate line for (n-1) clock cycles.

A gate pulse supplied to each of the gate lines may have a pulse width corresponding to two clock cycles, and is overlapped with the gate pulse supplied to the adjacent gate line for one clock cycle.

According to another aspect of the present invention, a method of driving an X-ray detector comprises the steps of: during a scrubbing period in which gate scanning is performed at least one time in order to initialize a photodiode of a plurality of light sensing pixels, generating a gate pulse for turning on a switching device included in each of the plurality of light sensing pixels for transmitting a detection signal from the photodiode of the plurality of light sensing pixels; transmitting the gate pulse to each switching device of the plurality of light sensing pixels via a plurality of gate lines; and outputting the detection signal from the plurality of light sensing pixels via a data line; wherein the generating of a gate pulse comprises generating the gate pulse so that gate pulses supplied to at least two gate lines partially overlap each other.

The gate pulse supplied to each gate line may have a pulse width corresponding to n clock cycles (where n is a natural number smaller than or equal to the number of rows of the plurality of light sensing pixels), and is overlapped with a gate pulse supplied to an adjacent gate line for (n-1) clock cycles.

A gate pulse supplied to each of the gate lines may have a pulse width corresponding to two clock cycles, and may be overlapped with the gate pulse supplied to the adjacent gate line for one clock cycle.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic block diagram of an X-ray detecting system according to an embodiment of the present invention;

FIG. 2 is a schematic view of an X-ray detector illustrated in FIG. 1 according to an embodiment of the present invention;

FIG. 3 is a structural diagram of a signal detecting unit of FIG. 2;

FIG. 4 is a cross-sectional view of a unit light sensing pixel of FIG. 2;

FIG. 5 is a timing diagram illustrating a method of generating an offset image and an X-ray image according to an embodiment of the present invention;

FIG. 6 is a timing diagram illustrating an example of a gate scanning operation;

FIG. 7 is a graph showing scrubbing efficiency according to a gate-on time;

FIG. 8 is a timing diagram illustrating a driving operation of an X-ray detector according to an embodiment of the present invention; and

FIG. 9 is a timing diagram illustrating a driving operation of an X-ray detector according to another embodiment of the present invention.

### DETAILED DESCRIPTION OF THE INVENTION

The present invention will now be described more fully with reference to the accompanying drawings, in which exemplary embodiments of the invention are shown. Descriptions of elements or operations which may be easily implemented by one of ordinary skill in the art may be omitted.

The description and the drawings are not provided for limitation, and the scope of the invention should be defined exclusively by the appended claims. The meaning of the terms used in the present specification and claims of the present invention should be construed as meanings and concepts not departing from the spirit and scope of the invention based on the principle that the inventor is capable of defining concepts of terms in order to describe his or her invention in the most appropriate way.

Hereinafter, preferred embodiments of the present invention will be described with reference to the attached drawings.

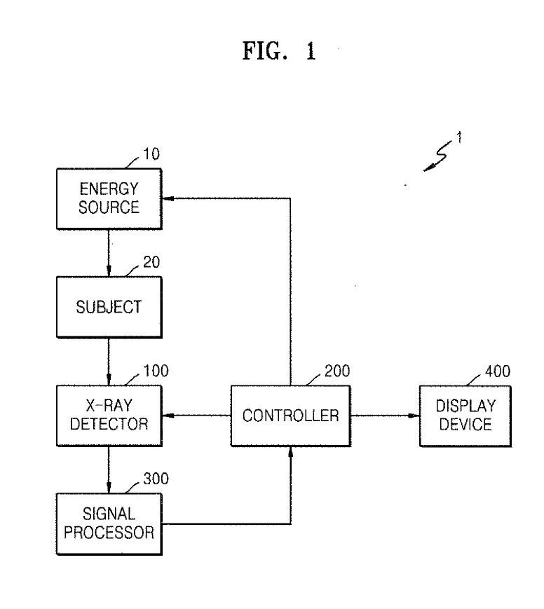

FIG. 1 is a schematic block diagram illustrating an X-ray detecting system according to an embodiment of the present invention.

Referring to FIG. 1, the X-ray detecting system 1 includes an energy source 10, an X-ray detector 100, a controller 200, a signal processor 300, and a display device 400.

The energy source 10 is a device for sending radiation, such as X-rays, toward a subject 20.

The X-ray detector 100 includes a plurality of light sensing pixels for sensing X-rays in a flat panel. The X-ray detector 100 also includes a plurality of photodiodes and a plurality of switching devices which detect X-rays penetrating the subject 20. If X-rays are applied to the photodiodes while a reverse bias is applied to the photodiodes, an electrical signal corresponding to the amount of X-rays which penetrate is generated in each photodiode. The electrical signals are read out via data lines, and are then inputted to a read out integrated circuit (to be discussed below).

The X-ray detector 100 performs an offset read out to obtain an offset image when X-rays are not emitted, or an X-ray read out to obtain an X-ray image when X-rays are emitted. In addition, the X-ray detector 100 achieves offset adjustment by performing gate scanning before performing the offset read out, and achieves signal initialization by performing gate scanning before performing the X-ray read out. When the X-ray detector 100 performs offset adjustment, gate scanning may be performed at least twice.

The controller 200 controls operations of the energy source 10, the X-ray detector 100, and the display device 400 so as to form an offset-corrected X-ray image. The controller 200 controls when and for how long the energy source 10 radiates X-rays. The controller 200 controls driving sequences for obtaining an offset image of the X-ray detector 100 and for obtaining an X-ray image.

The signal processor 300 converts the electrical signals outputted from the X-ray detector 100 into a digital signal. The signal processor 300 generates an offset image and an X-ray image from the digital signal. The current offset image may be updated by averaging a previously generated offset image and the current offset image. The signal processor 300 generates an offset-corrected X-ray image by subtracting the offset image, which is generated before X-rays are radiated, from the X-ray image.

The display device 400 displays the offset-corrected X-ray image. The display device 400 may be a liquid crystal display (LCD), an organic light-emitting display device, or a plasma display panel.

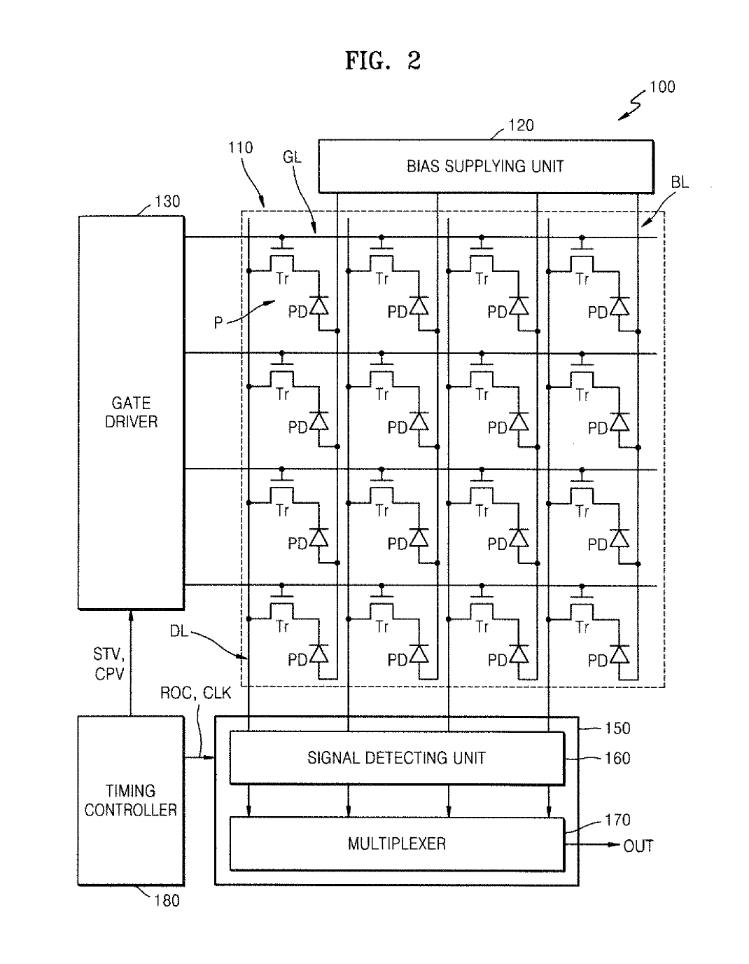

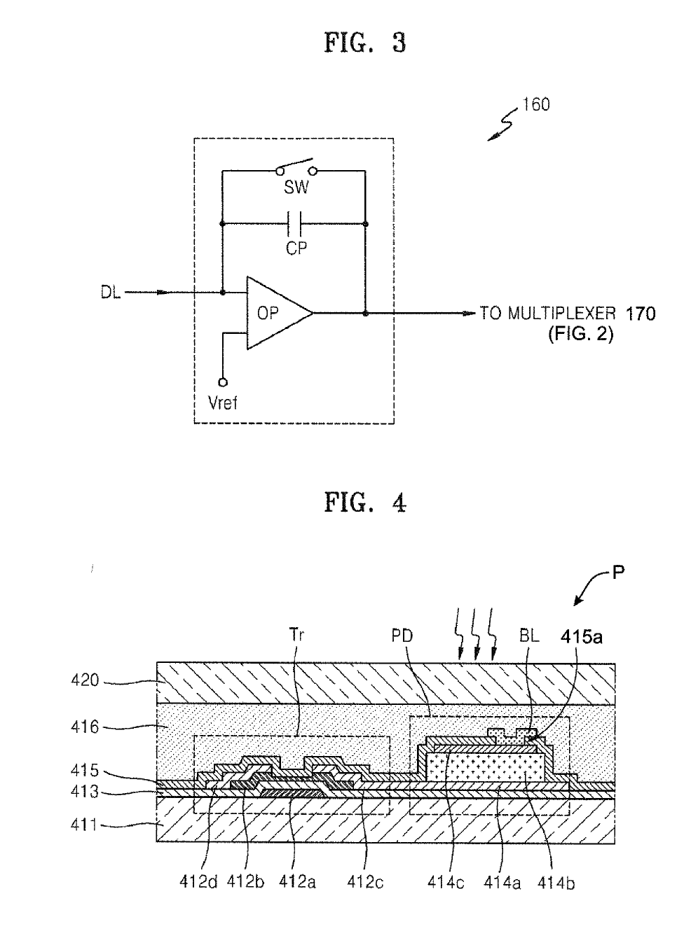

FIG. 2 is a schematic circuit diagram of an X-ray detector illustrated in FIG. 1 according to an embodiment of the present invention, and FIG. 3 is a structural diagram of a signal detecting unit of FIG. 2.

Referring to FIG. 2, the X-ray detector 100 includes a pixel unit 110, a bias supplying unit 120, a gate driver 130, a read out integrated circuit 150, and a timing controller 180. The read out integrated circuit 150 includes a signal detecting unit 160 and a multiplexer 170.

The pixel unit 110 senses X-rays radiated from the energy source 10, performs photoelectric conversion on the sensed signals, and outputs the resultant signals as electrical signals. The pixel unit 110 includes a plurality of light sensing pixels P arranged in a matrix form near where a plurality of gate lines GL and a plurality of data lines DL cross each other. The plurality of gate lines GL and the plurality of data lines DL may cross each other almost perpendicularly. FIG. 2 illustrates sixteen light sensing pixels P arranged in four columns and four rows, but the present invention is not limited thereto.

Each of the light sensing pixels P includes a photodiode PD which senses an X-ray and outputs a detection signal such as a photodetection voltage, and a switching device Tr which transfers the detection signal output from the photodiode PD to the read out integrated circuit 150 in response to a gate pulse. The switching device Tr may be, for example, a transistor. Hereinafter, a transistor Tr will be described as an example of the switching device Tr.

Each of the photodiodes PD senses X-rays radiated from the energy source 10 and generates a signal with respect to the sensed X-rays, and the photodiodes PD output the signal as the detection signal. The photodiodes PD convert incident light into an electrical signal using photoelectric conversion effects and may be PIN diodes. First electrodes of the photodiodes PD may be electrically connected to first electrodes of the transistors Tr, and second electrodes of the photodiodes PD may be electrically connected to a plurality of bias lines BL to which a bias voltage is applied.

The transistors Tr are switching devices for switching the electrical signal output from the photodiodes PD. Gate electrodes of the transistors Tr may be electrically connected to the gate lines GL, and source electrodes of the transistors Tr may be electrically connected to the read out integrated circuit 150 via the data lines DL.

The bias supplying unit 120 applies a driving voltage to each of the plurality of bias lines BL. The bias supplying unit 120 may selectively apply a reverse bias or a forward bias to the photodiodes PD.

The gate driver 130 sequentially applies gate pulses having a gate-on voltage level to the plurality of gate lines GL. A gate-on voltage level refers to a voltage level which turns on the transistors Tr of the light sensing pixels P. The transistors Tr of the light sensing pixels P are turned on in response to the gate pulses.

When one transistor Tr is turned on, a detection signal output from the photodiode PD is outputted to the read out integrated circuit 150 via the data lines DL. The gate driver 130 is formed in an integrated circuit (IC) form and may be mounted on a side of the pixel unit 110 or may be directly formed on a substrate, such as the pixel unit 110, through a thin-film process.

The read out integrated circuit 150 reads out the detection signal outputted from the transistors Tr turned on in response to the gate pulse. The read out integrated circuit 150 reads out the detection signal outputted from the light sensing pixels P during an offset read out in which an offset image is read out, and during an X-ray read out in which a detection signal after an X-ray exposure is read out.

The read out integrated circuit 150 includes the signal detecting unit 160 and the multiplexer 170.

Referring to FIG. 3, the signal detecting unit 160 includes a plurality of amplifying units respectively corresponding to the plurality of data lines DL. Each of the amplifying units includes an amplifier OP, a capacitor CP, and a reset device SW.

Further referring to FIG. 3, the amplifier OP includes a first input terminal connected to the data line DL, a second input terminal which receives a reference voltage Vref, and an output terminal. The reference voltage Vref may be a ground voltage. The first input terminal may be an inverse input of the amplifier OP, and the second input terminal may be a non-inverse input of the amplifier OP. A signal output from the output terminal of the amplifier OP is inputted to the multiplexer 170.

One end of the capacitor CP is electrically connected to the first input terminal of the amplifier OP, and another end of the capacitor CP is electrically connected to the output terminal of the amplifier OP.

The reset device SW resets the capacitor CP by discharging a voltage charged in the capacitor CP. The reset device SW is connected in parallel to the capacitor CP. One end of the reset device SW is electrically connected to the one end of the capacitor CP, and another end of the reset device SW is electrically connected to the other end of the capacitor CP. The reset device SW may comprise a switch capable of electrically connecting both ends of the capacitor CP to each other. When the switch of the reset device SW is turned on, both ends of the capacitor CP are electrically connected to each other, and a voltage charged in the capacitor CP is discharged. The switch of the reset device SW is turned on while performing gate scanning, thereby discharging the data lines DL.

The multiplexer 170 of FIG. 2 receives voltage signals from the amplifiers OP of the signal detecting unit 160 and sequentially outputs the voltage signals to the signal processor 300 of FIG. 1. The multiplexer 170 may include switches corresponding to the amplifiers OP.

In order to control the operation of the gate driver 130 of FIG. 2, the timing control unit 180 generates a start signal STV, a clock signal CPV, etc., and outputs them to the gate driver 130. Also, in order to control the operation of the read out integrated circuit 150, the timing controller 180 generates a read out control signal ROC or a read out clock signal CLK, and outputs them to the read out integrated circuit 150. The gate driver 130 and the read out integrated circuit 150 may be operated using different clock signals.

FIG. 4 is a cross-sectional view of a unit light sensing pixel of FIG. 2.

Referring to FIG. 4, the unit light sensing pixel P includes one transistor Tr and one photodiode PD on a base substrate 411. The transistor Tr includes a gate electrode 412a, an active pattern 412b, a first electrode 412c, and a second electrode 412d. The photodiode PD includes a first electrode 414a, a photo conductive layer 414b, and a second electrode 414c.

The base substrate 411 may have a plate shape. The base substrate 411 may be formed of a transparent material, for example, glass, quartz, or a synthetic resin.

The gate electrode 412a of the transistor Tr is formed on the base substrate 411. The gate electrode 412a may be formed so as to protrude from the gate line GL, and may be formed of a material which is the same as that of the gate line GL, for example, aluminum (Al) or an Al alloy.

The gate electrode 412a is covered by a gate insulating layer 413 which may be formed of silicon nitride (SiNx) or silicon oxide (SiOx).

The active pattern 412b of the transistor Tr is formed on the gate insulating layer 413. The active pattern 412b may include a channel layer formed on the gate insulating layer 413 and an ohmic contact layer formed on the channel layer. The channel layer may include amorphous silicon (a-Si), and the ohmic contact layer may include amorphous silicon (n+ a-Si or p+ a-Si) doped with high density ions.

The first electrode 412c and the second electrode 412d of the transistor Tr are formed on the active pattern 412b and are spaced apart from each other at a predetermined interval. The first electrode 412c and the second electrode 412d may be formed of a material which is the same as that of the data line DL, for example, molybdenum (Mo), a molybdenum-tungsten alloy (MoW), chromium (Cr), tantalum (Ta), titanium (Ti), or the like.

The first electrode 414a of the photodiode PD and the first electrode 412c of the transistor Tr are formed as a single body on the gate insulating layer 413 so as to be electrically connected to each other.

The photo conductive layer 414b is formed on the first electrode 414a of the photodiode PD. Although not shown in FIG. 4, the photo conductive layer 414b may have a structure in which an n-type silicon layer, an intrinsic silicon layer, and a p-type silicon layer are sequentially stacked.

The second electrode 414c of the photodiode PD is disposed opposite the first electrode 414a on the photo conductive layer 414b. The second electrode 414c may be formed of a transparent conductive material, for example, indium tin oxide (ITO), so that X-rays may be applied to the photo conductive layer 414b.

A passivation layer 415 is formed over all of the base substrate 411 so as to cover the photodiode PD and the transistor Tr. The passivation layer 415 may be formed of SiNx or SiOx.

A contact hole 415a for exposing the second electrode 414c of the photodiode PD is formed in the passivation layer 415. A bias line BL may be electrically connected to the second electrode 414c of the photodiode PD through the contact hole 415a.

An insulating layer 416 may be further formed over all of the base substrate 411 so as to cover the passivation layer 415 and the bias line BL. Thus, the panel 410 is completed.

A scintillator 420 is formed on the pixel unit 110, that is, on the insulating layer 416. The scintillator 420 changes X-rays which pass through the subject 20 from the energy source 10 and which are incident thereon into green light having a visible ray wavelength of 550 nm, and emits the green light toward the pixel unit 110. The scintillator 420 may be formed of cesium iodide.

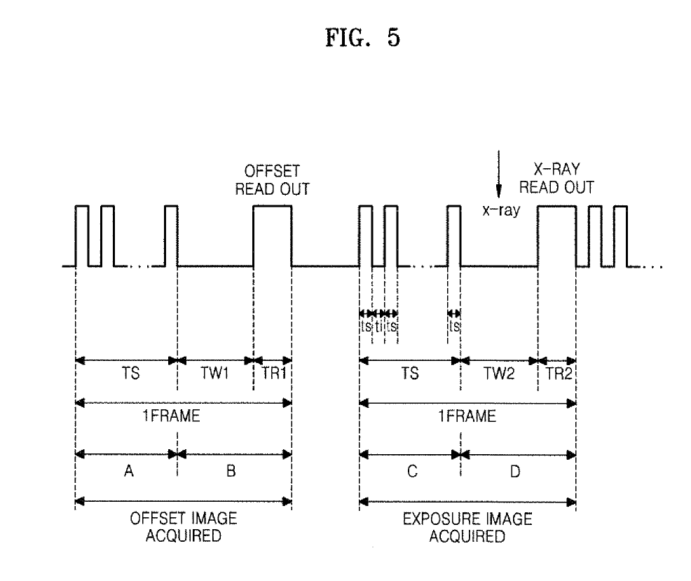

FIG. 5 is a timing diagram illustrating a method of generating an offset image and an X-ray image according to an embodiment of the present invention.

Referring to FIG. 5, the X-ray detector 100 obtains an offset image through a read out operation which is performed without radiating X-rays during an offset image acquisition period, and obtains an X-ray image in an exposure image acquisition period through a read out operation which is performed after radiation of X-rays.

The offset image acquisition period includes a first scrubbing period A and an offset read out period B.

During the first scrubbing period A, the X-ray detector 100 performs gate scanning n times. The gate scanning may be performed at least twice. A gate scanning time ts is when a gate pulse is sequentially applied from the first gate line to the last gate line so as to perform gate scanning. A gate scanning internal ti may be 0. Gate scanning is performed n times during the entire gate scanning time TS.

Specifically, a gate pulse is sequentially applied from the gate driver 130 to a plurality of gate lines GL, and the transistor Tr of each row is turned on by the gate pulse. Next, the transistor Tr is turned off. Here, the reset device SW of the signal detecting unit 160 is turned on and is electrically connected to the two ends of the capacitor CP. An electrical signal of the data line DL is discharged by the reset device SW. That is, data which is collected during scrubbing is discarded. When gate scanning is completed, the reset device SW is turned off. Also, during the first scrubbing period A, each photodiode PD is charged up to a predetermined initial potential between each gate scanning.

Scrubbing refers to initializing the X-ray detector 100 by resetting an image lag remaining in the photodiode PD. In addition, scrubbing is conducted in order to maintain an appropriate bias potential of the two ends of the photodiode PD between pauses. Also, scrubbing is conducted to reduce delay of the photodiode PD or the effect of incomplete charge recovery of the photodiode PD. After exposure, the amount of charge which is needed to recover the potentials of the two ends of the photodiode PD to an initial potential is integrated in a unit area of each light sensing pixel P over the time in which the X-rays are exposed, and is proportional to the amount of X-rays detected in each light sensing pixel P.

In the offset read out period B, the X-ray detector 100 maintains an idle state during an offset window time TW1. Here, the transistor Tr is turned off.

After the offset window time TW1 has passed, the X-ray detector 100 performs offset read out TR1 for reading an electrical signal of each light sensing pixel P.

Specifically, a gate pulse is sequentially applied from the gate driver 130 to a plurality of gate lines GL. The transistors Tr of each of the light sensing pixels P are turned on by the gate pulse. An electrical signal outputted by the turned-on transistor Tr is read out via the data line DL and is transmitted to the read out integrated circuit 150.

The signal processor 300 obtains an offset image based on the signal outputted by the read out integrated circuit 150. For example, an offset image may be updated by averaging the obtained offset image and a previously obtained offset image.

An exposure image acquisition period includes a second scrubbing period C and an X-ray read out period D.

In the second scrubbing period C, the X-ray detector 100 performs gate scanning n times. The gate scanning may be performed at least twice. A gate scanning time ts is when a gate pulse is sequentially applied from the first gate line to the last gate line so as to perform gate scanning. A gate scanning interval ti may be 0. Gate scanning is performed n times during the entire gate scanning time TS.

Specifically, a gate pulse is sequentially applied from the gate driver 130 to a plurality of gate lines GL, and the transistor Tr of each row is turned on by the gate pulse. A reset device SW of the signal detecting unit 160 is closed and is electrically connected to the two ends of the capacitor CP. That is, data which is collected during scrubbing is discarded. An electrical signal of the data line DL is discharged by the reset device SW. Also, during the second scrubbing period C, each photodiode PD is charged up to a predetermined initial potential between gate scannings.

When gate scanning is completed, the reset device SW is turned off.

In the X-ray read out period D, the X-ray detector 100 is exposed to an X-ray for a period of X-ray window time TW2. Here, the transistor Tr is turned off. When the X-ray detector 100 is exposed to an X-ray, the X-ray is absorbed by the scintillator 420, and light which is emitted from the scitillator 420 to the photodiode PD partially discharges the photodiode D. The amount of light emitted from the scitillator 420 to the photodiode PD is proportional to the amount of light of the X-ray absorbed by the scintillator 420.

After the X-ray window time TW2 has passed, the X-ray detector 100 performs an X-ray read out TR2 for reading an electrical signal of each light sensing pixel P.

In detail, a gate pulse is sequentially applied from the gate driver 130 to a plurality of gate lines GL. The transistor Tr of each of the light sensing pixels P is turned on by the gate pulse. An electrical signal generated in the photodiode PD during the X-ray window time TW2 is transmitted to the turned-on transistor Tr. An electrical signal outputted by the turned-on transistor Tr is read out via a data line DL, and is transmitted to the read out integrated circuit 150.

The signal processor 300 obtains an X-ray image based on the signal outputted by the read out integrated circuit 130.

The signal processor 300 subtracts the updated offset image from the X-ray image so as to generate an offset-corrected X-ray image.

FIG. 6 is a timing diagram illustrating an example of a gate scanning operation.

As illustrated in FIG. 6, a gate pulse is applied to each gate line GL during the first scrubbing period A and the second scrubbing period C of FIG. 5 so as to perform scrubbing. FIG. 6 illustrates six gate lines GL1 thru GL6, whereas the number of gate lines may vary according to embodiments. Also, FIG. 6 illustrates one gate scanning operation, and a gate scanning period T of FIG. 6 corresponds to the gate scanning time is of FIG. 5.

Gate scanning is initiated in response to a start pulse of a start signal STV. While the start pulse is applied, a gate pulse is sequentially applied starting from the first gate line GL1 in response to a clock pulse of a clock signal CPV. A pulse width t of the gate pulse is given the same length as a period of a clock signal CPV. As illustrated in FIG. 6, as a gate pulse is sequentially applied to the gate lines GL1 thru GL6, switching devices Tr of a plurality of pixels of the pixel unit 110 are sequentially turned on row by row so as to perform gate scanning. IGH denotes a current flowing through each data line DL.

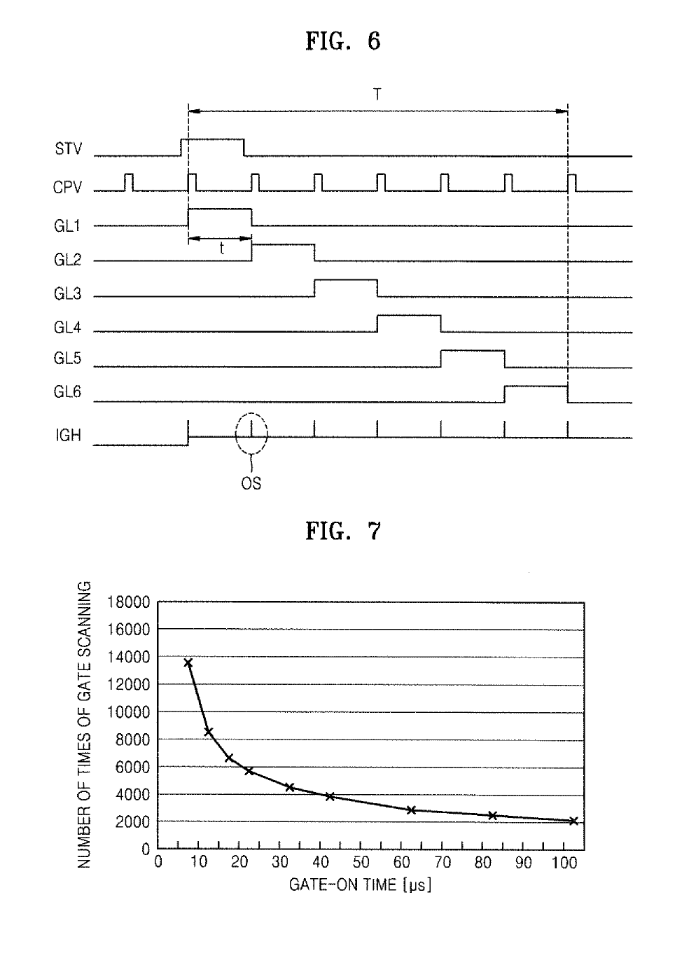

FIG. 7 is a graph showing scrubbing efficiency according to a gate-on time.

While scrubbing is performed, in order to appropriately initialize an X-ray detector and remove image lag, gate scanning is required to be performed a plurality of times. The number of times gate scanning needs to be performed for scrubbing may vary according to the gate-on time. The gate-on time refers to a time needed for a switching device Tr to be turned on, and corresponds to a pulse width of a gate pulse. In detail, as illustrated in FIG. 7, the longer the gate-on time, the smaller the number of times gate scanning needs to be performed for scrubbing. However, if time for scrubbing for a reset operation is increased, an image cycle time, which is the time needed for standby until a next X-ray photographing operation is performed, also increases. Thus, the shorter the scrubbing time, the better.

In order to reduce the scrubbing time, the frequency of a clock signal CPV input to the gate driver 130 may be increased. However, if this method is used, the gate-on time is also reduced, thereby reducing the reset effect of the photodiode PD by performing gate scanning one time. Consequently, the frequency of gate scanning for scrubbing is increased. As a result, increasing just the frequency of the clock signal CPV in the conventional driving method is of little effect with regard to reducing scrubbing time.

Another method of reducing scrubbing time is by applying a gate pulse to all of the gate lines GL1 thru GL6 at the same time so as to turn on switching devices Tr of all light sensing pixels P at the same time. However, when a gate pulse is applied, a current pulse OS is momentarily generated in a current of the data line DL as illustrated in FIG. 6. This is because the current momentarily increases when the switching devices Tr are turned on by the gate pulse. Accordingly, as described above, if the switching devices Tr of all light sensing pixels P are turned on at the same time by applying a gate pulse to all of the gate lines GL1 thru GL6 at the same time, a rush current may be inputted to the read out integrated circuit 150 via a data line DL. As a result, this method may be burdensome to the read out integrated circuit 150 and may reduce the lifetime of the read out integrated circuit 150. Also, in order to output a detection signal from all of the light sensing pixels P at the same time, driving power needs to be supplied to all of the light sensing pixels P at the same time, which is also burdensome to the bias supplying unit 120.

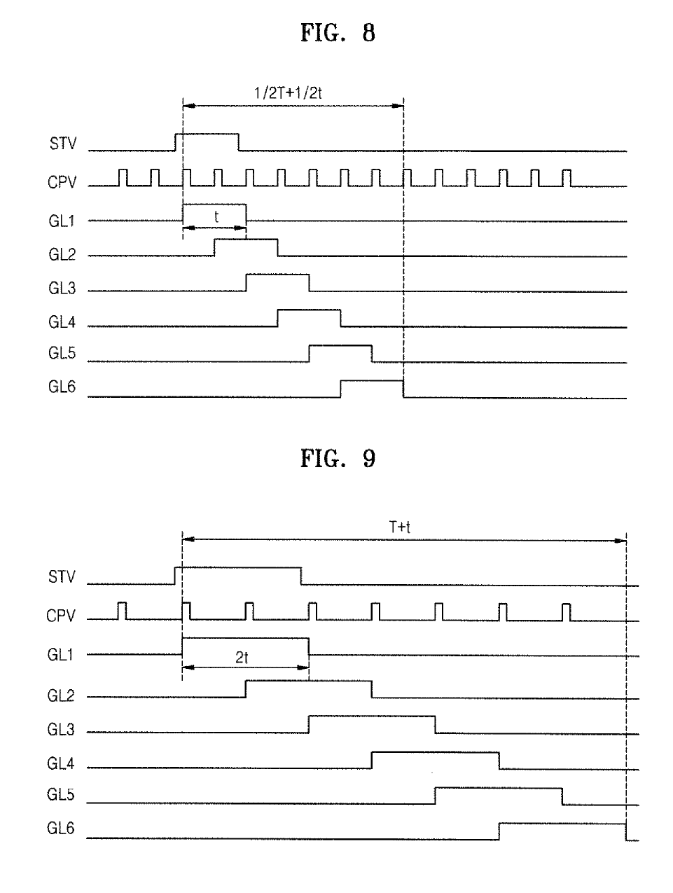

FIG. 8 is a timing diagram illustrating a driving operation of an X-ray detector according to an embodiment of the present invention.

The gate driver 130, according to embodiments of the present invention, generates gate pulses such that gate pulses applied to the plurality of gate lines GL1 thru GL6 overlap one another as illustrated in FIG. 8, and the gate driver 130 sequentially outputs the gate pulses to the plurality of gate lines GL1 thru GL6. For example, the pulse width of a gate pulse corresponds to two clock cycles, and one gate pulse may be overlapped with another gate pulse applied to an adjacent gate line by one clock cycle.

According to the embodiment illustrated in FIG. 8, the frequency of the clock signal CPV is doubled compared to the previous frequency during the first and second scrubbing periods A and C, respectively, and the pulse width of the gate pulse is maintained the same. Thus, scrubbing time is reduced by almost 50% compared to a situation wherein overlapped driving is not performed. To this end, a start signal STV applied to the gate driver 130 may have a start pulse width which allows the start signal STV to include two clock pulses during the first and second scrubbing periods A and C, respectively.

Further referring to FIG. 8, the frequency of the clock signal CPV during the first and second scrubbing periods A and C, respectively, may be increased n times, and a gate pulse may be varied so as to have a pulse width of n clock cycles. Here, n is a natural number which is smaller than or equal to the number of gate lines. For example, during the first and second scrubbing periods A and C, respectively, the clock signal CPV may have three times the frequency of a clock signal CPV of the offset read out period B and the X-ray read out period D, and a gate pulse corresponding to that of three clock cycles. In this case, the scrubbing time is reduced by nearly 33% compared to the situation wherein overlapped driving is not performed.

Overlapped driving of the gate lines GL1 thru GL6 may be performed in various ways. For example, a gate pulse generation block may be formed of a level latch such that a pulse width of a gate pulse follows a pulse width of a start pulse, and a start pulse width of a start signal STV may be adjusted so that gate pulses of the plurality of gate lines GL1 thru GL6 overlap one another. Alternatively, a shift register (not shown) for generating a gate signal may be designed to be driven by a plurality of clock signals and a plurality of start signals so that gate pulses of the plurality of gate lines GL1 thru GL6 overlap one another.

FIG. 9 is a timing diagram illustrating a driving operation of an X-ray detector according to another embodiment of the present invention.

Referring to FIG. 9, during first and second scrubbing periods A and C, respectively, the frequency of the clock signal CPV is maintained the same as that of a clock signal CPV during the offset read out period B and the X-ray read out period D, but a gate pulse width of the clock signal CPV is increased and a plurality of gate lines GL1 thru GL6 are driven such that gate pulses of the plurality of gate lines GL1 thru GL6 overlap one another, thereby reducing the scrubbing time. In this case, the gate-on time is increased compared to the situation wherein overlapped driving is not performed. Thus the frequency of gate scanning needed for scrubbing is reduced, thereby reducing scrubbing time.

For example, as illustrated in FIG. 9, the gate driver 130 may generate a gate pulse, the pulse width of which corresponds to two clock cycles such that each of gate pulses of the plurality of gate lines GL1 thru GL6 is overlapped with another gate pulse of an adjacent gate line by one clock cycle. The frequency of gate scanning needed for scrubbing is to be determined by the pulse width of the gate pulse, and as the pulse width of the gate pulse increases, the frequency of gate scanning for scrubbing is reduced, thereby reducing the scrubbing time.

According to the embodiments of the present invention, the initialization time of the X-ray detector may be reduced while maintaining image lag removing efficiency.

Also, according to the embodiments of the present invention, the initialization time of the X-ray detector may be reduced while barely increasing the burden on a power source unit and a read-out integrated circuit.

While this invention has been particularly shown and described with reference to exemplary embodiments thereof, it will be understood by those of ordinary skill in the art that various changes in form and detail may be made therein without departing from the spirit and scope of the invention as defined by the appended claims. The exemplary embodiments should be considered in a descriptive sense only, and not for purposes of limitation. Therefore, the scope of the invention is defined not by the detailed description of the invention but by the appended claims, and all differences within the scope of the invention will be construed as being included in the present invention.

What is claimed is:

1. An X-ray detector, comprising:
a plurality of light sensing pixels, each including a photodiode for generating an electrical detection signal corresponding to incident light and a switching device for transmitting the detection signal;
a gate driver for supplying, to the switching device via a plurality of gate lines, a gate pulse for turning on the switching device; and
a read out integrated circuit for reading out the detection signal from the plurality of light sensing pixels;
wherein gate pulses supplied to at least two gate lines partially overlap one another during a scrubbing period in which gate scanning is performed at least one time in order to initialize the photodiodes of the plurality of light sensing pixels.

2. The X-ray detector of claim 1, wherein each of the gate pulses supplied to the gate lines has a pulse width corresponding to n clock cycles, where n is a natural number no greater than a number of rows of the plurality of light sensing pixels, and each gate pulse is overlapped with a gate pulse supplied to an adjacent gate line for (n-1) clock cycles.

3. The X-ray detector of claim 2, wherein a gate pulse supplied to each of the gate lines has a pulse width corresponding to two clock cycles and is overlapped with the gate pulse supplied to the adjacent gate line for one clock cycle.

4. A method of driving an X-ray detector, the method comprising the steps of:
during a scrubbing period in which gate scanning is performed at least one time in order to initialize photodiodes of a plurality of light sensing pixels, generating a gate pulse for turning on a switching device included in each of the light sensing pixels for transmitting a detection signal from each of the photodiodes of the plurality of light sensing pixels;
transmitting the gate pulse to each switching device of the plurality of light sensing pixels via a plurality of gate lines; and
outputting the detection signal from the plurality of light sensing pixels via a data line;
wherein the step of generating the gate pulse comprises generating the gate pulse so that gate pulses supplied to at least two gate lines partially overlap each other.

5. The method of claim 4, wherein the gate pulse supplied to each gate line has a pulse width corresponding to n clock cycles, where n is a natural number not grater than a number of rows of the plurality of light sensing pixels, and each gate pulse is overlapped with a gate pulse supplied to an adjacent gate line for (n-1) clock cycles.

6. The method of claim 5, wherein a gate pulse supplied to each of the gate lines has a pulse width corresponding to two clock cycles, and is overlapped with the gate pulse supplied to the adjacent gate line for one clock cycle.
